(19) United States
(12) Patent Application Publication
(10) Pub. No.: US 2020/0160784 A1
(43) Pub. Date: May 21, 2020

(54) DISPLAY CONTROL METHOD AND DEVICE AND DISPLAY PANEL

(71) Applicants: HEFEI XINSHENG OPTOELECTRONICS TECHNOLOGY CO., LTD., Hefei (CN); BOE TECHNOLOGY GROUP CO., LTD., Beijing (CN)

(72) Inventors: Haixia Xu, Beijing (CN); Zhidong Yuan, Beijing (CN); Wenchao Bao, Beijing (CN); Can Yuan, Beijing (CN); Song Meng, Beijing (CN)

(21) Appl. No.: 16/529,352

(22) Filed: Aug. 1, 2019

(30) Foreign Application Priority Data
Nov. 19, 2018 (CN) 201811377259.2

(51) Int. Cl. G09G 3/3233

(52) U.S. Cl. CPC G09G 3/3233; G09G 2320/0233; G09G 2320/041

(57) ABSTRACT

The present disclosure proposes a display control method and device, and a display panel. The display control method includes: acquiring a temperature compensation value of a row of pixel units in a display panel on which temperature compensation is currently performed; acquiring, according to the temperature compensation value, a brightness ratio corresponding to the temperature compensation value; and compensating for brightness of a row of pixel units in the display panel on which temperature compensation is not performed according to the brightness ratio.

### CROSS-REFERENCE TO RELATED APPLICATION(S)

This application claims priority to the Chinese Patent Application No. 201811377259.2, filed on Nov. 19, 2018, which is incorporated herein by reference in its entirety.

### TECHNICAL FIELD

The present disclosure relates to the field of display technology, and more particularly, to a display control method and device, and a display panel.

### BACKGROUND

Organic Light-Emitting Diode (OLED for short) display panels have advantages such as self-illumination, wide viewing angle, almost infinitely high contrast, low power consumption, and extremely high reaction speed, etc.

An OLED is a current-type device, and when current flows into the OLED, a temperature of a display panel rises as lighting time increases. Thereby, a detected voltage value increases, and a temperature compensation value becomes small. The small temperature compensation value causes a gate-source voltage of a driving Thin Film Transistor (TFT) in an OLED display panel on which temperature compensation is performed to become small, thereby resulting in occurrence of a scanning boundary in a compensation process, which affects the display effect. The change in the temperature compensation value, that is, a compensation coefficient K, may represent a change in an electron mobility of the driving TFT. Specifically, K is inversely proportional to the electron mobility and is affected by temperature, illumination, etc.

### SUMMARY

According to a first aspect of the embodiments of the present disclosure, there is provided a display control method, comprising:

acquiring a temperature compensation value of a row of pixel units in a display panel on which temperature compensation is currently performed;

acquiring, according to the temperature compensation value, a brightness ratio corresponding to the temperature compensation value; and

compensating for brightness of a row of pixel units in the display panel on which temperature compensation is not performed according to the brightness ratio.

In an embodiment, compensating for brightness of a row of pixel units in the display panel on which temperature compensation is not performed comprises:

multiplying the brightness ratio by the brightness of the row of pixel units on which temperature compensation is not performed.

In an embodiment, acquiring a brightness ratio corresponding to the temperature compensation value comprises:

acquiring the brightness ratio according to the temperature compensation value based on a preset correspondence relationship between temperature compensation values and brightness ratios.

In an embodiment, acquiring a temperature compensation value of a row of pixel units in a display device on which temperature compensation is currently performed comprises:

acquiring a temperature of the display panel; and

determining the temperature compensation value of the row of pixel units on which temperature compensation is currently performed according to the temperature.

In an embodiment, determining the temperature compensation value of the row of pixel units on which temperature compensation is currently performed according to the temperature comprises:

determining the temperature compensation value of the row of pixel units on which temperature compensation is currently performed according to the temperature, based on a preset correspondence relationship between temperatures and temperature compensation values.

In an embodiment, acquiring the temperature of the display panel comprises:

acquiring a plurality of current values of the display panel within a set duration;

calculating a sum of the plurality of current values; and

acquiring the temperature of the display panel according to the sum.

In an embodiment, acquiring the temperature according to the sum comprises:

acquiring the temperature according to the sum, based on a preset correspondence relationship between sums of current values and temperatures.

In an embodiment, acquiring a plurality of current values of the display panel within a set duration comprises:

acquiring a current value of the display panel periodically within the set duration to obtain the plurality of current values.

According to a second aspect of the embodiments of the present disclosure, there is provided a display control device, comprising:

a processor; and

a memory coupled to the processor, and having stored thereon instructions which, when executed on the processor, cause the processor to be configured to:

acquire a temperature compensation value of a row of pixel units in a display panel on which temperature compensation is currently performed;

acquire, according to the temperature compensation value, a brightness ratio corresponding to the temperature compensation value; and

compensate for brightness of a row of pixel units in the display panel on which temperature compensation is not performed according to the brightness ratio.

In an embodiment, the processor is further configured to:

multiply the brightness ratio by the brightness of the row of pixel units on which temperature compensation is not performed.

In an embodiment, the processor is further configured to:

acquire the brightness ratio according to the temperature compensation value based on a preset correspondence relationship between temperature compensation values and brightness ratios.

In an embodiment, the processor is further configured to:

acquire a temperature of the display panel; and

determine the temperature compensation value of the row of pixel units on which temperature compensation is currently performed according to the temperature.

In an embodiment, the processor is further configured to:

determine the temperature compensation value of the row of pixel units on which temperature compensation is currently performed according to the temperature, based on a preset correspondence relationship between temperatures and temperature compensation values.

In an embodiment, the processor is further configured to:

acquire a plurality of current values of the display panel within a set duration;

calculate a sum of the plurality of current values; and

acquire the temperature of the display panel according to the sum.

In an embodiment, the processor is further configured to:

acquire the temperature according to the sum, based on a preset correspondence relationship between sums of current values and temperatures.

In an embodiment, the processor is further configured to:

acquire a current value of the display panel periodically within the set duration to obtain the plurality of current values.

According to a third aspect of the embodiments of the present disclosure, there is provided a display panel, comprising the display control device described above.

In an embodiment, the display panel is an Organic Light Emitting Diode (OLED) display panel.

According to a fourth aspect of the embodiments of the present disclosure, there is provided a non-transitory computer readable storage medium having stored thereon a computer program, wherein the program, when executed by a processor, implements the display control method described above.

### BRIEF DESCRIPTION OF THE ACCOMPANYING DRAWINGS

FIG. 1 is a diagram of a temperature compensation pixel circuit of an OLED display panel;

FIG. 2 is a schematic diagram of a scanning boundary phenomenon;

FIG. 3 is a flowchart of a display control method according to an embodiment of the present disclosure;

FIG. 4 is a flowchart of a display control method according to another embodiment of the present disclosure;

FIG. 5 is a schematic diagram of a mapping relationship between sums of current values and temperatures;

FIG. 6 is a schematic diagram of a mapping relationship between temperatures and compensation values K;

FIG. 7 is a structural diagram of a display control apparatus according to an embodiment of the present disclosure;

FIG. 8 is a structural diagram of a display panel according to an embodiment of the present disclosure; and

FIG. 9 is a structural diagram of a display control device according to an embodiment of the present disclosure.

### DETAILED DESCRIPTION

The embodiments of the present disclosure will be described in detail below, and examples of the embodiments are illustrated in the accompanying drawings, wherein the same or similar reference numerals are used to refer to the same or similar elements or elements having the same or similar functions. The embodiments described below with reference to the accompanying drawings are illustrative, are intended to explain the present disclosure, and should not be construed as limiting the present disclosure.

The display control method and device and display panel according to the embodiments of the present disclosure will be described below with reference to the accompanying drawings.

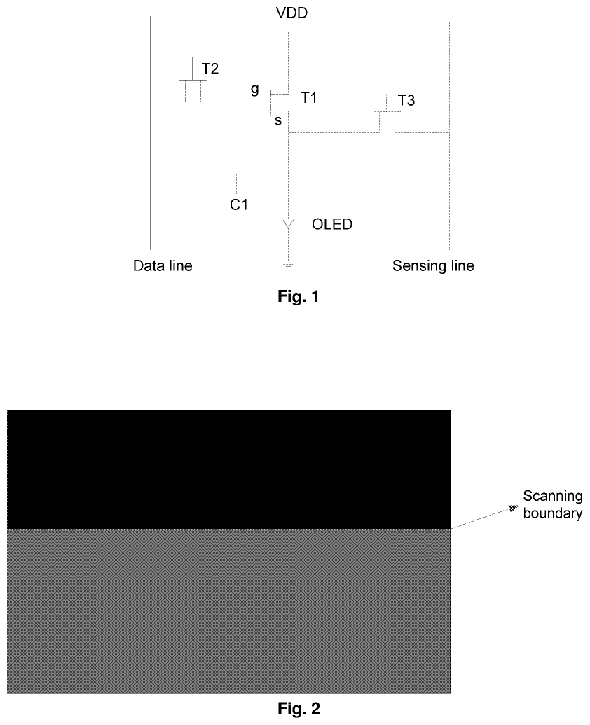

FIG. 1 is a diagram of a temperature compensation pixel circuit of an OLED display panel. As shown in FIG. 1, the temperature compensation pixel circuit of the OLED display panel comprises: a driving TFT T1, a driving TFT T2, and a sensing TFT T3; a storage capacitor C1; an OLED; a data line; a sensing line; and a first selection signal line G1, a second selection signal line G2 and VDD. The VDD provides corresponding operating current to the OLED. The OLED is a current-type device. Therefore, when driving current I_{OLED} generated by the driving TFT1 flows through the OLED, the temperature of the display panel may rise as the lighting time increases, and the rise in the temperature may cause a difference in a voltage value detected by the sensing line under the same voltage. A temperature compensation calculation formula of the OLED display panel is: Vgs=K×\sqrt{L}+Vth, where K is a temperature compensation value, K=1/(a×\sqrt{Vsense}), Vgs is a gate-source voltage difference of T1, Vth is a threshold voltage of T1, Vsense is a voltage detected by the sensing line, and a is a constant. When the temperature rises, Vsense becomes large, K becomes small, and thereby Vgs becomes small according to the compensation calculation formula. The difference in compensation data occurs, i.e., a compensated Vgs is different from an uncompensated Vgs. Therefore, during real-time compensation, naked eyes may see a scanning boundary phenomenon as shown in FIG. 2 during display. Specifically, for example, when the rise in the temperature of the display panel is sensed, temperature compensation is performed on the display panel progressively, and one image frame is displayed on the entire display panel when temperature compensation is performed on one row of pixels of the display panel. Brightness corresponding to a row of pixels on which temperature compensation is performed is lower than brightness corresponding to a row of pixels on which temperature compensation is not performed, and thereby when a certain image frame is displayed in real time, one part of the image frame is bright and the other part of the image frame is dark, as shown in FIG. 2.

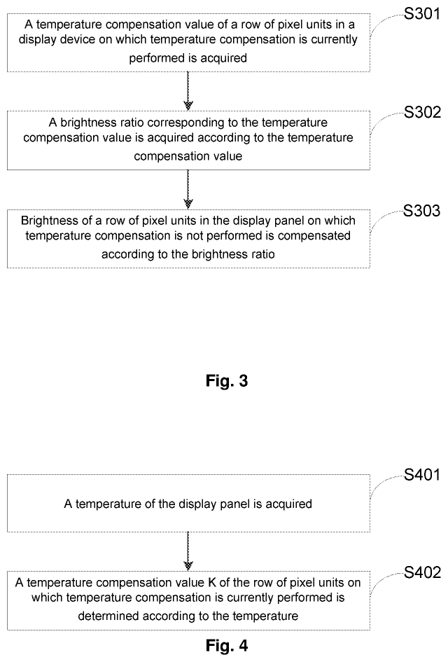

FIG. 3 is a flowchart of a display control method according to an embodiment of the present disclosure. As shown in FIG. 3, the display control method comprises the following steps.

In S301, a temperature compensation value of a row of pixel units in a display device on which temperature compensation is currently performed is acquired.

In S302, a brightness ratio corresponding to the temperature compensation value is acquired according to the temperature compensation value.

In the embodiment of the present disclosure, after the temperature compensation value K of the row of pixel units on which temperature compensation is currently performed is acquired in step S101, a compensation value K which is acquired last time may be acquired in cached data, and a ratio of the compensation value K which is currently acquired to the compensation value K which is acquired last time is calculated.

In S303, brightness of a row of pixel units in the display panel on which temperature compensation is not performed is compensated according to the brightness ratio.

In an embodiment of the present disclosure, the brightness ratio is multiplied by the brightness of the row of pixel units on which temperature compensation is not performed. Specifically, a correspondence relationship between temperature compensation values and brightness ratios may be preset. When the temperature compensation value of the row of pixels in the display panel on which temperature compensation is currently performed is acquired, the brightness ratio corresponding to the acquired temperature compensation value may be acquired according to the preset correspondence relationship between temperature compensation values and brightness ratios. Thereby, when one frame image is displayed in a case where temperature compensation is performed on the row of pixels using the temperature compensation value, the acquired brightness ratio may be applied to the subsequent row of pixels on which temperature compensation is not performed, so that brightness of the compensated row of pixels is consistent with brightness of the uncompensated row of pixels, thereby eliminating the scanning boundary problem and improving the display effect.

In the embodiment of the present disclosure, applying the acquired brightness ratio to the subsequent row of pixels on which temperature compensation is not performed may specifically comprise: multiplying the acquired brightness ratio by the brightness of the subsequent row of pixels on which temperature compensation is not performed. For example, input RGB data for the row of pixels on which temperature compensation is not performed is multiplied by the acquired brightness ratio, to obtain output RGB data.

In the display control method according to the embodiment of the present disclosure, firstly, a temperature compensation value of a row of pixel units in the display device on which temperature compensation is currently performed is acquired; then a brightness ratio corresponding to the temperature compensation value is acquired according to the temperature compensation value; and finally, the brightness of the row of pixel units in the display panel on which temperature compensation is not performed is compensated according to the brightness ratio. The brightness ratio is multiplied by the brightness of the row of pixel units on which temperature compensation is not performed, so that brightness of a subsequent row of pixels is consistent with the brightness of the current row of pixels on which temperature compensation is performed, thereby avoiding the occurrence of a scanning boundary and improving the display effect.

As another possible implementation, as shown in FIG. 4, FIG. 4 is a flowchart of a display control method according to another embodiment of the present disclosure, and step S301 may further comprise the following step.

In S401, a temperature of the display panel is acquired.

In the embodiment of the present disclosure, the temperature of the display panel is periodically acquired.

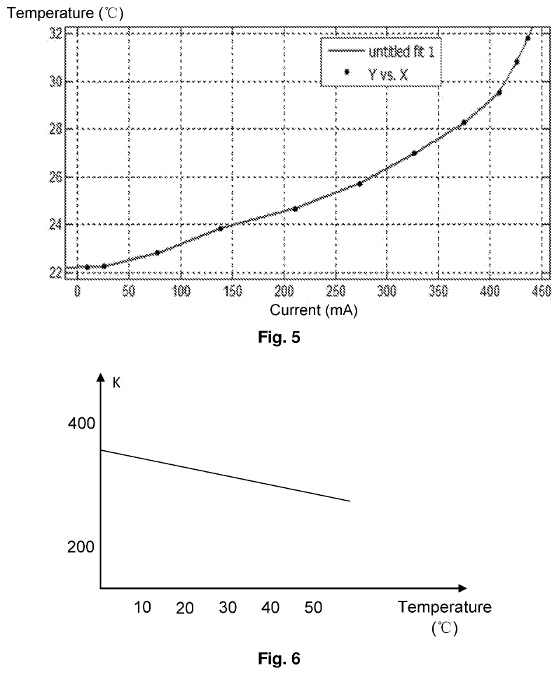

As a possible implementation, the step S401 may specifically comprise: acquiring a plurality of current values of the display panel within a set duration; calculating a sum of the plurality of current values; and acquiring the temperature according to the sum. Specifically, the set duration may be preset, and the set duration may be one minute. During the set duration (i.e., one minute), the current value of the display panel is periodically acquired to obtain a plurality of current values, and then the obtained plurality of current values are added to obtain a sum of the plurality of current values. For example, the current value of the display panel is collected every second, and after the set duration (i.e., one minute) expires, current values collected for 60 times are added to obtain a sum, and then the temperature of the display panel is acquired according to the sum. As a feasible implementation, a correspondence relationship between sums of current values and temperatures as shown in FIG. 5 may be preset, and then the temperature is acquired according to the sum in the preset correspondence relationship between sums of current values and temperatures, wherein the correspondence relationship between sums of current values and temperatures may be obtained through detection by an INA226 chip.

In S402, a temperature compensation value K of the row of pixel units on which temperature compensation is currently performed is determined according to the temperature.

In the embodiment of the present disclosure, the temperature compensation value K of the current row of pixel units is acquired according to the temperature of the display panel acquired in step S401. As a possible implementation, the step may specifically comprise: searching for a compensation value K of the current row of pixel units according to the temperature in the preset correspondence relationship between temperatures and temperature compensation values K. Specifically, the correspondence relationship between temperatures and compensation values K as shown in FIG. 6 may be pre-stored. After the temperature of the display panel is acquired in step S401, the relationship may be queried to obtain the temperature compensation value K of the current row of pixel units.

In the display control method according to the embodiment of the present disclosure, the current temperature of the display panel is acquired according to the sum of the plurality of current values of the display panel, and then the compensation value K of the current row of pixel units is acquired according to the current temperature of the display panel. With the brightness compensation method, the scanning boundary phenomenon may be effectively eliminated and the display effect may be improved.

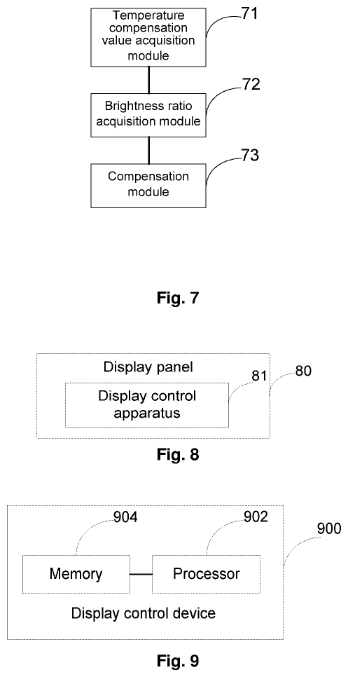

FIG. 7 is a structural diagram of a display control apparatus according to an embodiment of the present disclosure. As shown in FIG. 7, the display control apparatus comprises:

a temperature compensation value acquisition module 71 configured to acquire a temperature compensation value of a row of pixel units in a display panel on which temperature compensation is currently performed;

a brightness ratio acquisition module 72 configured to acquire, according to the temperature compensation value, a brightness ratio corresponding to the temperature compensation value; and

a compensation module 73 configured to compensate for brightness of a row of pixel units in the display panel on which temperature compensation is not performed according to the brightness ratio.

Further, in a possible implementation of the embodiments of the present disclosure, the temperature compensation value acquisition module 71 is specifically configured to acquire a temperature of the display panel; and determine the temperature compensation value of the row of pixel units on which temperature compensation is currently performed according to the temperature.

Further, in a possible implementation of the embodiments of the present disclosure, the temperature compensation value acquisition module 71 is specifically configured to determine the temperature compensation value of the row of pixel units on which temperature compensation is currently performed according to the temperature based on a preset correspondence relationship between temperatures and temperature compensation values.

Further, in a possible implementation of the embodiments of the present disclosure, the temperature compensation value acquisition module 71 is specifically configured to acquire a plurality of current values of the display panel within a set duration; calculate a sum of the plurality of current values; and acquire the temperature of the display panel according to the sum.

Further, in a possible implementation of the embodiments of the present disclosure, the temperature compensation value acquisition module 71 is specifically configured to acquire the temperature according to the sum based on a preset correspondence relationship between sums of current values and temperatures.

Further, in a possible implementation of the embodiments of the present disclosure, the temperature compensation value acquisition module 71 is specifically configured to acquire a current value of the display panel periodically within the set duration to obtain the plurality of current values.

Further, in a possible implementation of the embodiments of the present disclosure, the brightness ratio acquisition module 72 is specifically configured to acquire the brightness ratio according to the temperature compensation value based on a preset correspondence relationship between temperature compensation values and brightness ratios.

Further, in a possible implementation of the embodiments of the present disclosure, the compensation module 73 is specifically configured to multiply the brightness ratio by the brightness of the row of pixel units on which temperature compensation is not performed.

It should be illustrated that the above explanation of the embodiment of the display control method is also applicable to the display control apparatus according to the embodiment, and will not be described in detail here again.

In the display control apparatus according to the embodiment of the present disclosure, firstly, a temperature compensation value of a row of pixel units in the display device on which temperature compensation is currently performed is acquired; then a brightness ratio corresponding to the temperature compensation value is acquired according to the temperature compensation value; and finally, the brightness of the row of pixel units in the display panel on which temperature compensation is not performed is compensated according to the brightness ratio. The brightness ratio is multiplied by the brightness of the row of pixel units on which temperature compensation is not performed, so that brightness of a subsequent row of pixels is consistent with the brightness of the row of pixels on which temperature compensation is currently performed, thereby avoiding the occurrence of a scanning boundary and improving the display effect.

In order to implement the above embodiments, the embodiments of the present disclosure further provide a display panel 80, as shown in FIG. 8, comprising: the display control apparatus 81 as shown in the above embodiment.

Further, in a possible implementation of the embodiments of the present disclosure, the display panel 80 may specifically be an OLED display panel.

The embodiments of the present disclosure further provide a display control device 900, of which a structural block diagram is shown in FIG. 9. The image adjustment device comprises a processor 902 and a memory 904. It should be illustrated that a structure in the structural diagram of the display control device shown in FIG. 9 is merely exemplary and not restrictive, and the display control device may further comprise other components depending on practical application requirements.

In an embodiment of the present disclosure, the processor 902 and the memory 904 may communicate with each other directly or indirectly. The processor 902 may communicate with components such as the memory 904 via a connection through a network. The network may comprise a wireless network, a wired network, and/or any combination thereof. The network may comprise a local area network, the Internet, a telecommunications network, an Internet of Things based on the Internet and/or telecommunications network, and/or any combination thereof etc. The wired network may be used for communication by means of twisted pair, a coaxial cable or optical fiber transmission etc., and the wireless network may use a communication manner such as a 3G/4G/5G mobile communication network, Bluetooth, Zigbee or WiFi etc. A type and a function of the network may not be limited here in the present disclosure.

The processor 902 may control other components in the display control device to perform desired functions. The processor 902 may be a device having a data processing capability and/or a program execution capability, such as a Central Processing Unit (CPU), or a Graphics Processing Unit (GPU), etc. The CPU may be an X86 or ARM architecture etc. The GPU may be directly integrated into a motherboard or built into a Northbridge of the motherboard. The GPU may also be built into the CPU.

The memory 904 may comprise any combination of one or more computer program products, which may comprise various forms of computer readable storage media, such as a volatile memory and/or a nonvolatile memory. The volatile memory may comprise, for example, a Random Access Memory (RAM) and/or a cache etc. The non-volatile memory may comprise, for example, a Read Only Memory (ROM), a hard disk, an Erasable Programmable Read Only Memory (EPROM), a portable Compact Disk Read Only Memory (CD-ROM), a Universal Serial Bus (USB) memory, a flash memory, etc.

One or more computer readable codes or instructions may be stored in the memory 904, and the processor 902 may execute the computer instructions to implement the display control methods described above. A detailed description of a processing procedure of the display control methods may be known with reference to the related description of the display control methods according to the embodiments of the present disclosure, and will not be described in detail. Various applications and various data, such as image data sets and various data used and/or generated by the applications, etc., may also be stored in the computer readable storage medium.

In order to implement the above embodiments, the embodiments of the present disclosure further provide a non-temporary computer readable storage medium having stored thereon a computer program which, when executed by a processor, implements the steps in the display control method according to any of the embodiments described above.

In the description of the present specification, the description with reference to the terms “one embodiment”, “some embodiments”, “example”, “specific example”, or “some examples” etc. means that a specific feature, structure, material, or characteristic described in connection with the embodiment or example is included in at least one embodiment or example of the present disclosure. In the present specification, the schematic representation of the above terms is not necessarily directed to the same embodiment or example. Further, the specific feature, structure, material, or characteristic described may be combined in a suitable manner in any one or more embodiments or examples. In addition, various embodiments or examples described in the specification, as well as features of various embodiments or examples, may be combined and integrated by those skilled in the art without a contradiction.

Although the embodiments of the present disclosure have been shown and described above, it may be understood that the above embodiments are illustrative and are not to be construed as limiting the present disclosure. Changes, modifications, substitutions and variations may be made to the above embodiments by those of ordinary skill in the art within the scope of the present disclosure.

I/We claim:

1. A display control method, comprising:
acquiring a temperature compensation value of a first row of pixel units in a display panel on which temperature compensation is currently performed;
acquiring, according to the temperature compensation value, a brightness ratio corresponding to the temperature compensation value; and
compensating for brightness of a second row of pixel units in the display panel on which temperature compensation is not currently performed according to the brightness ratio.

2. The display control method according to claim 1, wherein compensating for brightness of the second row of pixel units in the display panel on which temperature compensation is not currently performed comprises:
multiplying the brightness ratio by a brightness of the second row of pixel units on which temperature compensation is not currently performed.

3. The display control method according to claim 1, wherein acquiring the brightness ratio corresponding to the temperature compensation value comprises:
acquiring the brightness ratio according to the temperature compensation value based on a preset correspondence relationship between temperature compensation values and brightness ratios.

4. The display control method according to claim 1, wherein acquiring the temperature compensation value of the first row of pixel units in the display device on which temperature compensation is currently performed comprises:
acquiring a temperature of the display panel; and
determining the temperature compensation value of the first row of pixel units on which temperature compensation is currently performed according to the temperature.

5. The display control method according to claim 4, wherein determining the temperature compensation value of the first row of pixel units on which temperature compensation is currently performed according to the temperature comprises:
determining the temperature compensation value of the first row of pixel units on which temperature compensation is currently performed according to the temperature, based on a preset correspondence relationship between temperatures and temperature compensation values.

6. The display control method according to claim 4, wherein acquiring the temperature of the display panel comprises:
acquiring a plurality of current values of the display panel within a set duration;
calculating a sum of the plurality of current values; and
acquiring the temperature of the display panel according to the sum.

7. The display control method according to claim 6, wherein acquiring the temperature according to the sum comprises:
acquiring the temperature according to the sum, based on a preset correspondence relationship between sums of current values and temperatures.

8. The display control method according to claim 6, wherein acquiring the plurality of current values of the display panel within the set duration comprises:
acquiring a current value of the display panel periodically within the set duration to obtain the plurality of current values.

9. A display control device, comprising:
a processor; and
a memory coupled to the processor, and having stored thereon instructions which, when executed on the processor, cause the processor to be configured to:
acquire a temperature compensation value of a first row of pixel units in a display panel on which temperature compensation is currently performed;
acquire, according to the temperature compensation value, a brightness ratio corresponding to the temperature compensation value; and
compensate for brightness of a second row of pixel units in the display panel on which temperature compensation is not currently performed according to the brightness ratio.

10. The display control device according to claim 9, wherein the processor is further configured to:
multiply the brightness ratio by the brightness of the second row of pixel units on which temperature compensation is not currently performed.

11. The display control device according to claim 9, wherein the processor is further configured to:
acquire the brightness ratio according to the temperature compensation value based on a preset correspondence relationship between temperature compensation values and brightness ratios.

12. The display control device according to claim 9, wherein the processor is further configured to:
acquire a temperature of the display panel; and
determine the temperature compensation value of the first row of pixel units on which temperature compensation is currently performed according to the temperature.

13. The display control device according to claim 12, wherein the processor is further configured to:
determine the temperature compensation value of the first row of pixel units on which temperature compensation is currently performed according to the temperature, based on a preset correspondence relationship between temperatures and temperature compensation values.

14. The display control device according to claim 12, wherein the processor is further configured to:
acquire a plurality of current values of the display panel within a set duration;
calculate a sum of the plurality of current values; and
acquire the temperature of the display panel according to the sum.

15. The display control device according to claim 14, wherein the processor is further configured to:
acquire the temperature according to the sum, based on a preset correspondence relationship between sums of current values and temperatures.

16. The display control device according to claim 14, wherein the processor is further configured to:
acquire a current value of the display panel periodically within the set duration to obtain the plurality of current values.

17. A display panel, comprising the display control device according to claim 9.

18. The display panel according to claim 17, wherein the display panel is an Organic Light Emitting Diode (OLED) display panel.

19. A non-transitory computer readable storage medium having stored thereon a computer program, wherein the program, when executed by a processor, implements the display control method according to claim 1.
